(19) United States
(12) Patent Application Publication
(10) Pub. No.: US 2011/0114039 A1
(43) Pub. Date: May 19, 2011

(54) BUSH AND ENGINE THAT IS EQUIPPED WITH THE BUSH

(75) Inventors: Seung Yong Lee, Yongin-si (KR); Gyuhwan Kim, Suwon-si (KR); Yun Seok Kim, Yongin-si (KR); Yong Sun Park, Yongin-si (KR); Bong Sang Lee, Suwan-city (KR)

(73) Assignees: HYUNDAI MOTOR COMPANY, Seoul (KR); KIA MOTORS CORPORATION, Seoul (KR)

(21) Appl. No.: 12/876,635

(22) Filed: Sep. 7, 2010

(30) Foreign Application Priority Data
Nov. 19, 2009 (KR) 10-2009-0112239

(51) Int. Cl. F01P 5/10; F16L 3/08

(52) U.S. Cl. 123/41.44; 16/2.1

(57) ABSTRACT

A bush assembly may include an inner pipe, in which a bolt hole is formed substantially in the middle thereof, an outer pipe, through which the inner pipe is inserted, wherein an inner circumference of the outer pipe is spaced with a predetermined gap from an exterior circumference of the inner pipe and the outer pipe includes a bent portion that is bent at a lower portion thereof and extends in a radial direction with a predetermined length, and an elastic member that couples the inner pipe and the outer pipe in the predetermined gap and is fixed to a lower surface of the bent portion.

### CROSS-REFERENCE TO RELATED APPLICATION

The present application claims priority to Korean Patent Application No. 10-2009-0112239 filed on Nov. 19, 2009, the entire contents of which is incorporated herein for all purposes by this reference.

### BACKGROUND OF THE INVENTION

1. Field of the Invention

The present invention relates to an engine that is equipped with a bush. More particularly, the present invention relates to an engine that is equipped with a motor driven coolant pump that circulates coolant, and a bush that is interposed between the coolant pump and a cylinder block.

2. Description of Related Art

A cooling system of some kind is necessary in any internal combustion engine. If no cooling system were provided, parts would melt from the heat of the burning fuel and pistons would expand so much they would seize.

The cooling system includes an engine water jacket, a thermostat, a coolant pump, a radiator, a radiator cap, a fan, a fan drive belt, and a coolant pump drive belt.

Generally, the coolant pump does not have a self-driving torque. Accordingly, the coolant pump uses kinetic energy transferred from the engine crankshaft.

If the engine is started, the coolant pump is operated regardless of the coolant temperature and the driving condition of the engine in such a manner that the coolant circulates in the water jacket and the radiator of the engine.

Because the coolant is forcibly circulated before the engine is warmed up, the exhaust gas temperature is increased slowly. Meanwhile, the exhaust gas temperature must be raised to a high temperature, for example 250° C., so as to improve the purification efficiency of the exhaust gas to a normal condition.

Recently, a motor driven coolant pump has been applied to the engine, and the motor driven coolant pump is only operated during a predetermined period, decreases the warm-up time of the engine, and improves the purification efficiency of the exhaust gas particularly after starting the engine.

In addition, a fastening device that fixes the coolant pump to the engine and absorbs vibration between them is being developed.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a bush and an engine that is equipped with the bush having advantages of absorbing vibration and securely fixing a coolant pump to the engine.

In an aspect of the present invention, the bush assembly may include an inner pipe, in which a bolt hole is formed substantially in the middle thereof, an outer pipe, through which the inner pipe is inserted, wherein an inner circumference of the outer pipe is spaced with a predetermined gap from an exterior circumference of the inner pipe and the outer pipe includes a bent portion that is bent at a lower portion thereof and extends in a radial direction with a predetermined length, and an elastic member that couples the inner pipe and the outer pipe in the predetermined gap and is fixed to a lower surface of the bent portion.

The elastic member formed at the lower surface of the bent portion may include at least a projecting portion that protrudes in a predetermined distance in a longitudinal direction of the inner pipe from the lower surface of the bent portion.

At least a penetration hole may be formed in the elastic member fixed between the inner pipe and the outer pipe in a longitudinal direction of the inner pipe, and the at least a penetration hole is arrayed in a circumference direction of the inner pipe with a predetermined distance therebetween.

The bush assembly may further include an air guide groove formed between the at least a projecting portion at a lower side of the elastic member formed at the lower surface of the bent portion and fluid-communicating with the at least a penetration hole.

The bush assembly may further include an air releasing groove formed at an upper surface of the elastic member along a circumference direction of the inner pipe and fluid-communicating with the at least a penetration hole.

A lower end surface of the at least a projecting portion may be disposed lower than a lower end of the inner pipe in a longitudinal direction of the inner pipe, wherein the lower end of the inner pipe is disposed lower than the lower end surface of the bent portion and wherein upper end surfaces of the inner pipe and the outer pipe are disposed on the same level.

In another aspect, the present invention may include an engine including a cylinder block, a coolant pump that is disposed at one side of the cylinder block, the bush assembly of claim 1, which is interposed between the coolant pump and the cylinder block, and a fastening bolt that is mounted through the bolt hole of the bush assembly to couple the coolant pump to the cylinder block.

As stated above, in a bush and an engine that is equipped with the bush according to the present invention, an elastic member such as rubber that is interposed between the inner pipe and the outer pipe absorbs vibration that is formed therebetween, and the bush securely fixes the coolant pump to the engine.

Further, the elastic member that is formed on the outer surface of the bent portion of the outer pipe to protrude in the length direction of the inner pipe efficiently absorbs the vibration, and securely fixes the coolant pump to the cylinder block of the engine.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of a coolant pump including an exemplary bush according to the present invention.

FIG. 2 is a perspective view of an exemplary bush for mounting a coolant pump on an engine according to the present invention.

FIG. 3 is a sectional perspective view of an exemplary bush for mounting a coolant pump on the engine according to the present invention.

FIG. 4 is a cross-sectional view showing a coolant pump and an engine that are assembled to each other by an exemplary bush according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

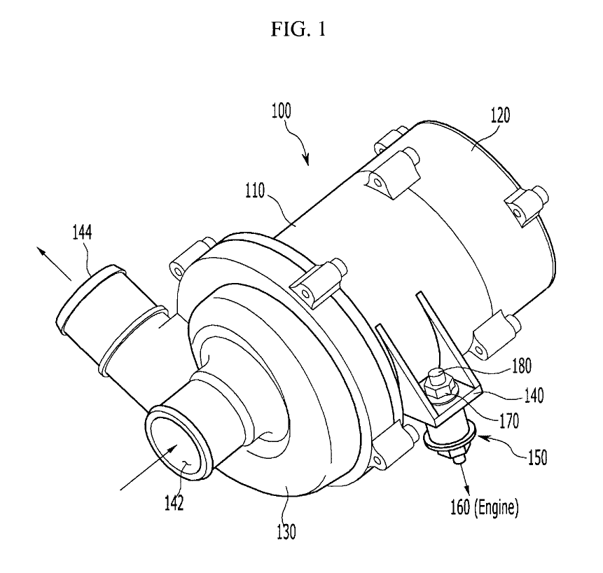

FIG. 1 is a perspective view of a coolant pump according to an exemplary embodiment of the present invention.

Referring to FIG. 1, a coolant pump 100 includes a motor housing 110, a driver case 120, an impeller housing 130, and a bracket 140.

As constituent elements of electric motor, a stator, a rotor, and a drive shaft are disposed inside the motor housing 110, and an electric supply set is built in the driver case 120 to supply the stator or the rotor with electrical energy.

An impeller is disposed in the impeller housing 130, and an inlet 142 for inhaling the coolant and an outlet 144 for supplying the coolant are formed in the impeller housing 130.

The bracket 140 is formed on one side of the exterior circumference of the motor housing 110, and the coolant pump 100 is mounted on the cylinder block through the bracket 140.

A bush 150 is interposed between the bracket and one side surface of the cylinder block, and a fastening bolt 180 penetrates the bracket 140, the bush 150, and the cylinder block 160 to securely fix the coolant pump 100 to the cylinder block 160.

The bush 150 fixes the coolant pump 100 to the cylinder block, and simultaneously absorbs vibration that is formed between the coolant pump 100 and the cylinder block.

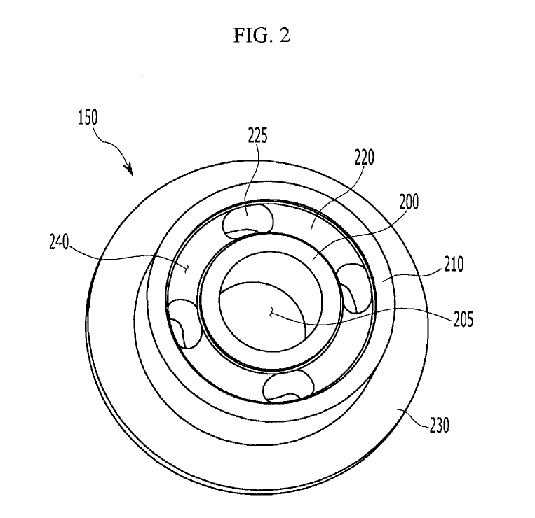

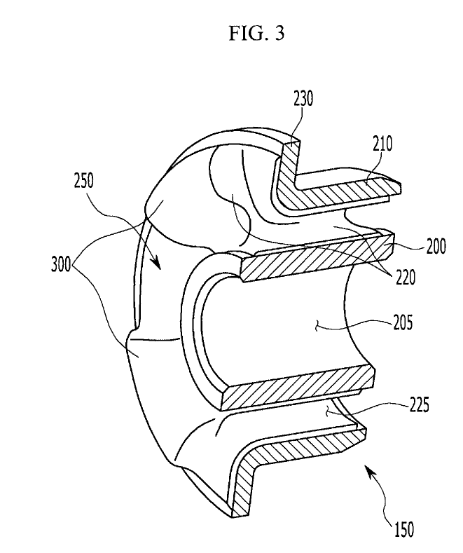

Referring to FIG. 2 and FIG. 3, a detail structure of the bush 150 is explained.

FIG. 2 is a perspective view of a bush for mounting a coolant pump on an engine according to an exemplary embodiment of the present invention, and FIG. 3 is a sectional perspective view of a bush for mounting a coolant pump on the engine according to an exemplary embodiment of the present invention.

Referring to FIG. 2, the bush 150 includes an inner pipe 200, an outer pipe 210, and an elastic member 220.

A bolt hole 205 is formed along the center axis of the inner pipe 200, the interior circumference of the outer pipe 210 is disposed with a predetermined gap from the exterior circumference of the inner pipe 200, and the elastic member 220 is interposed between the inner pipe 200 and the outer pipe 210.

Here, because the elastic member 220 is a flexible material such as rubber, it is effective for absorbing the vibration between the inner pipe 200 and the outer pipe 210.

Penetration holes 225 that are interposed between the inner pipe 200 and the outer pipe 210 are formed in the elastic member 220. The vibration or the oscillation that is formed between the inner pipe 200 and the outer pipe 210 is effectively absorbed through the penetration holes 225.

Referring to FIG. 3, the inner pipe 200 is inserted through the outer pipe 210, and one end of the outer pipe 210 is bent in an outer side direction to form a bent portion 230 along the circumference direction of the outer pipe 210.

The elastic member 220 is interposed between the inner pipe 200 and the outer pipe 210, and is formed on the outer side surface of the bent portion 230.

Further, the elastic member 220 protrudes on the outer side surface of the bent portion 230 to form a projecting portion 300. The projecting portion 300 is formed along the bent portion 230 with a predetermined gap at an exterior circumference of the outer pipe 210.

As shown in FIG. 3, the penetration hole 225 is formed in the elastic member 220 that is interposed between the inner pipe 200 and the outer pipe 210, and it is desirable that the projecting portion 300 is not formed corresponding to the penetration holes 225.

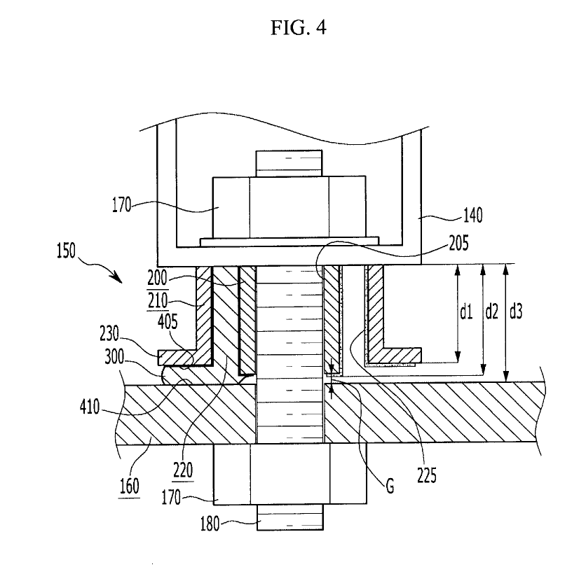

FIG. 4 is a cross-sectional view showing a coolant pump and an engine that are assembled to each other according to an exemplary embodiment of the present invention.

Referring to FIG. 4, the bush 150 is interposed between the cylinder block 160 and the bracket 140 of the motor housing 110 of the coolant pump 100, and the bolt 180 is disposed to penetrate the bracket 140, the bolt hole 205 of the bush 150, and the cylinder block 160.

Here, a nut 170 is engaged with both ends of the bolt 180 to fix the bracket 140 on the cylinder block 160.

The bush 150 that is interposed between the bracket 140 and the cylinder block 160 has a structure that absorbs the vibration between the coolant pump 100 and the cylinder block 160.

Further, the lower end portions of the inner pipe 200 and the outer pipe 210 do not contact the surface of the cylinder block 160. That is, a predetermined gap (G) is formed between the lower end of the inner pipe and an upper surface of the cylinder block 160.

In an exemplary embodiment of the present invention, the inner pipe 200 has a first length d1 from the upper end of the bush, the outer pipe has a second length d2 from the upper end of the bush, and the bush has a third length d3 from the upper end thereof, wherein the third length d3 is longer than the second length d2, and the second length d2 is longer than the first length d1.

More specifically, the projecting portion 300 of the elastic member 220 is interposed between a lower surface 405 of the bent portion 230 and the upper surface 410 of the cylinder block 160.

Accordingly, the vibration of the cylinder block 160 is absorbed by the projecting portion 300, and conversely the vibration of the bracket 140 is not directly transferred to the cylinder block 160.

Further, the bent portion 230 has a structure that is bent at the outer side of the outer pipe 210, and the elastic member 220 is formed on the outer side surface of the bent portion 230 in such a manner that the projecting portion 300 with a wide area contacts with the upper surface 410 of the cylinder block 160 to improve the assembly strength.

In an exemplary embodiment of the present invention, the projecting portion 300 is formed along the bent portion 230 with a predetermined gap in such a manner that the vibration absorption performance is improved.

In another exemplary embodiment of the present invention, an air guide groove 250 may be formed between the projecting portions 300 to fluid-communicate with the penetration hole 225 such that air trapped in the penetration hole 225 may be released therethrough while the projection portion 300 is compressed.

In further another exemplary embodiment of the present invention, an air releasing groove 240 may be formed at upper portion of the elastic member 220 along a circumference direction thereof and fluid-communicate with the penetration hole 225. In this configuration, the air trapped in the penetration holes 225 fluid-communicating with each other through the air releasing groove 240 may be effectively released through the air guide groove 250 while the projection portion 300 is compressed.

For convenience in explanation and accurate definition in the appended claims, the terms “upper”, “lower”, “interior”, “exterior”, “outer”, and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A bush assembly, comprising:
an inner pipe, in which a bolt hole is formed substantially in the middle thereof;
an outer pipe, through which the inner pipe is inserted, wherein an inner circumference of the outer pipe is spaced with a predetermined gap from an exterior circumference of the inner pipe and the outer pipe includes a bent portion that is bent at a lower portion thereof and extends in a radial direction with a predetermined length; and
an elastic member that couples the inner pipe and the outer pipe in the predetermined gap and is fixed to a lower surface of the bent portion.

2. The bush assembly of claim 1, wherein the elastic member formed at the lower surface of the bent portion includes at least a projecting portion that protrudes in a predetermined distance in a longitudinal direction of the inner pipe from the lower surface of the bent portion.

3. The bush assembly of claim 2, wherein at least a penetration hole is formed in the elastic member fixed between the inner pipe and the outer pipe in a longitudinal direction of the inner pipe, and the at least a penetration hole is arrayed in a circumference direction of the inner pipe with a predetermined distance therebetween.

4. The bush assembly of claim 3, further including an air guide groove formed between the at least a projecting portion at a lower side of the elastic member formed at the lower surface of the bent portion and fluid-communicating with the at least a penetration hole.

5. The bush assembly of claim 4, further including an air releasing groove formed at an upper surface of the elastic member along a circumference direction of the inner pipe and fluid-communicating with the at least a penetration hole.

6. The bush assembly of claim 2, wherein a lower end surface of the at least a projecting portion is disposed lower than a lower end of the inner pipe in a longitudinal direction of the inner pipe.

7. The bush assembly of claim 6, wherein the lower end of the inner pipe is disposed lower than the lower end surface of the bent portion.

8. The bush assembly of claim 7, wherein upper end surfaces of the inner pipe and the outer pipe are disposed on the same level.

9. An engine, comprising:
a cylinder block;
a coolant pump that is disposed at one side of the cylinder block;
the bush assembly of claim 1, which is interposed between the coolant pump and the cylinder block; and
a fastening bolt that is mounted through the bolt hole of the bush assembly to couple the coolant pump to the cylinder block.

10. The engine of claim 9, wherein the elastic member formed at the lower surface of the bent portion includes at least a projecting portion that protrudes in a predetermined distance in a longitudinal direction of the inner pipe from the lower surface of the bent portion.

11. The engine of claim 10, wherein at least a penetration hole is formed in the elastic member fixed between the inner pipe and the outer pipe in a longitudinal direction of the inner pipe, and the at least a penetration hole is arrayed in a circumference direction of the inner pipe with a predetermined distance therebetween.

12. The engine of claim 11, further including an air guide groove formed between the at least a projecting portion at a lower side of the elastic member formed at the lower surface of the bent portion and fluid-communicating with the at least a penetration hole.

13. The engine of claim 12, further including an air releasing groove formed at an upper surface of the elastic member along a circumference direction of the inner pipe and fluid-communicating with the at least a penetration hole.

14. The engine of claim 10, wherein a lower end surface of the at least a projecting portion is disposed lower than a lower end of the inner pipe in a longitudinal direction of the inner pipe.

15. The engine of claim 14, wherein the lower end of the inner pipe is disposed lower than the lower end surface of the bent portion.

16. The engine of claim 15, wherein upper end surfaces of the inner pipe and the outer pipe are disposed on the same level.
